(19) United States
(12) Patent Application Publication
(10) Pub. No.: US 2026/0230905 A1
(43) Pub. Date: Aug. 6, 2026

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN)

(21) Appl. No.: 19/146,630

(22) PCT Filed: Jan. 9, 2023
(86) PCT No.: PCT/CN2023/071466

§ 371 Date: Jul. 9, 2025

(51) Int. Cl. H04W 28/02

(52) U.S. Cl. CPC H04W 28/0268

(57) ABSTRACT

An information processing method is performed by a Policy Control Function (PCF) and includes: sending a subscription request based on a received delay notification, wherein the delay notification is used to indicate a first delay, and the subscription request is used to request a second delay associated with the first delay, wherein the first delay includes a delay of an uplink Service Data Flow (SDF) and the second delay includes a delay of a downlink SDF; or the first delay includes the delay of the downlink SDF and the second delay includes the delay of the uplink SDF.

### CROSS-REFERENCE TO RELATED APPLICATION(S)

The present application is a U.S. National Stage of International Application No. PCT/CN2023/071466 filed on Jan. 9, 2023, the disclosure of which is incorporated herein by reference in its entirety.

### TECHNICAL FIELD

The present disclosure relates to, but is not limited to, the field of communication technology, and in particular to an information processing method and apparatus, a communication device, and a storage medium.

### BACKGROUND

Services like mobile media services, Extended Reality (XR) services such as Augmented Reality (AR) or Virtual Reality (VR), cloud gaming services, video-based robot or drone remote control services will contribute more and more traffic to the fifth generation mobile communication technology (5G) network. These services may involve multiple data streams of one User Equipment (UE) and data streams of multiple UE, and the consistency among the Quality of Service (QOS) authorization and execution is guaranteed. However, in the actual service process, the network delay status and/or the delay requirements of the Application Function (AF) service will directly affect the QoS authorization of each data stream, and even affect whether the XRM service function can be successful.

### SUMMARY

According to a first aspect of the embodiments of the present disclosure, an information processing method is provided, which is performed by a Policy Control Function (PCF) and includes:
sending a subscription request based on a received delay notification, where the delay notification is used to indicate a first delay, and the subscription request is used to request a second delay associated with the first delay.

The first delay includes the delay of an uplink Service Data Flow (SDF), and the second delay includes the delay of a downlink SDF. Alternatively, the first delay includes the delay of the downlink SDF, and the second delay includes the delay of the uplink SDF.

According to a second aspect of the embodiments of the present disclosure, an information processing method is provided, which is performed by a User Plane Function (UPF) and includes: receiving a subscription request, where the subscription request is used to request a second delay associated with a first delay.

The first delay includes the delay of the uplink SDF, and the second delay includes the delay of the downlink SDF. Alternatively, the first delay includes the delay of the downlink SDF, and the second delay includes the delay of the uplink SDF.

According to a third aspect of the embodiments of the present disclosure, there is provided an information processing method, which is performed by an Application Function (AF) and comprises:
receiving at least one of a first delay or a second delay.

The first delay includes the delay of the uplink SDF, and the second delay includes the delay of the downlink SDF.

Alternatively, the first delay includes the delay of the downlink SDF, and the second delay includes the delay of the uplink SDF.

According to a fourth aspect of the embodiments of the present disclosure, a communication device is provided, including:
a processor; and
a memory for storing executable instructions of the processor.

The processor is configured to implement the information processing method in any embodiment(s) of the present disclosure when running the executable instructions.

It should be understood that the above general description and the detailed description below are only examples and explanatory, and cannot limit the embodiments of the present disclosure.

### BRIEF DESCRIPTION OF THE DRAWINGS

FIG. 1 is a schematic diagram of a wireless communication system according to an example embodiment.

FIG. 2 is a schematic diagram of an information processing method according to an example embodiment.

FIG. 3 is a schematic diagram of an information processing method according to an example embodiment.

FIG. 4 is a schematic diagram of an information processing method according to an example embodiment.

FIG. 5 is a schematic diagram of an information processing method according to an example embodiment.

FIG. 6 is a schematic diagram of an information processing method according to an example embodiment.

FIG. 7 is a schematic diagram of an information processing method according to an example embodiment.

FIG. 8 is a schematic diagram of an information processing method according to an example embodiment.

FIG. 9 is a schematic diagram of an information processing method according to an example embodiment.

FIG. 10 is a schematic diagram of an information processing method according to an example embodiment.

FIG. 11 is a schematic diagram of an information processing method according to an example embodiment.

FIG. 12 is a schematic diagram of an information processing method according to an example embodiment.

FIG. 13 is a schematic diagram of an information processing method according to an example embodiment.

FIG. 14 is a schematic diagram of an information processing method according to an example embodiment.

FIG. 15 is a schematic diagram of an information processing method according to an example embodiment.

FIG. 16 is a schematic diagram of an information processing method according to an example embodiment.

FIG. 17 is a schematic diagram of an information processing method according to an example embodiment.

FIG. 18 is a block diagram of an information processing apparatus according to an example embodiment.

FIG. 19 is a block diagram of an information processing apparatus according to an example embodiment.

FIG. 20 is a block diagram of an information processing apparatus according to an example embodiment.

FIG. 21 is a block diagram of a base station according to an example embodiment.

FIG. 22 is a schematic diagram of a network architecture of a 5G system according to an example embodiment.

### DETAILED DESCRIPTION OF THE EMBODIMENTS

Here, example embodiments will be described in detail, examples of which are shown in the accompanying drawings. When the following description refers to the drawings, unless otherwise indicated, the same numbers in different drawings represent the same or similar elements. The embodiments described in the following example embodiments do not represent all the implementations consistent with the embodiments of the present disclosure. Instead, they are only examples of apparatus/devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms, unless the context clearly indicates other meanings. It should also be understood that the term “and/or” used herein refers to and includes any or all possible combinations of one or more associated items as listed.

It should be understood that although the terms first, second, third, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at” or “when” or “in response to”.

Reference may be made to FIG. 1, which shows a schematic structural diagram of a wireless communication system provided by an embodiment of the present disclosure.

As shown in FIG. 1, the wireless communication system may include a number of user devices 110 and a number of access network devices 120. The wireless communication system may be a 4th generation mobile communication technology (4G) system, also known as a Long Term Evolution (LTE) system. Alternatively, the wireless communication system may also be a 5G system, also known as a new air interface system or a 5G NR system. Further alternatively, the wireless communication system may also be a next generation system of the 5G system, etc.

The user device 110 may be a device that provides voice and/or data connectivity to a user. The user device 110 may communicate with one or more core networks via a Radio Access Network (RAN). The user device 110 may be an IoT user device, such as a sensor device, a mobile phone (or a “cellular” phone), and a computer with an IoT user device. For example, it may be a fixed, portable, pocket-sized, handheld, computer-built-in, or vehicle-mounted device. For example, it may be a station (STA), a subscriber unit, a subscriber station, a mobile station, a mobile, a remote station, an access point, a remote terminal, an access terminal, a user terminal, a user agent, or a user equipment (UE). Alternatively, the user device 110 may also be a device of an unmanned aerial vehicle. Alternatively, the user device 110 may also be a vehicle-mounted device, for example, a driving computer with wireless communication function, or a wireless user device connected to an external driving computer. Alternatively, the user device 110 may also be a roadside device, for example, a street lamp, a signal lamp, or other roadside device with wireless communication function.

The access network device 120 may be a network-side device in a wireless communication system. The access network device 120 may be an evolved base station (eNB) used in a 4G system. Alternatively, the access network device 120 may also be a base station (gNB) using a centralized and distributed architecture in a 5G system. Alternatively, the access network device 120 may also be an access network in a 5G system, which may be called a New Generation-Radio Access Network (NG-RAN). When the access network device 120 adopts a centralized and distributed architecture, it generally includes a Centralized Unit (CU) and at least two Distributed Units (DUs). The centralized unit is provided with a protocol stack of a Packet Data Convergence Protocol (PDCP) layer, a Radio Link Control (RLC) layer, and a Medium Access Control (MAC) layer. The distributed unit is provided with a physical (PHY) layer protocol stack. The embodiments of the present disclosure do not limit the specific implementation(s) of the access network device 120.

A wireless connection may be established between the access network device 120 and the user device 110 through a radio air interface. In different implementations, the radio air interface is a radio air interface based on the fourth generation mobile communication network technology (4G) standard. Alternatively, the radio air interface is a radio air interface based on the fifth generation mobile communication network technology (5G) standard. For example, the radio air interface is a new air interface. Alternatively, the radio air interface may also be a radio air interface based on the next generation mobile communication network technology standard of 5G.

In some embodiments, an End to End (E2E) connection may also be established between user devices 110, for example in scenarios like vehicle to vehicle (V2V) communication, vehicle to infrastructure (V2I) communication and vehicle to pedestrian (V2P) communication for vehicle to everything (V2X) communication.

Here, the user device may be considered as a terminal device in the following embodiments.

In some embodiments, the wireless communication system may also include a core network device 130.

Several access network devices 120 are respectively connected to the core network device 130. The core network device 130 may be a core network device in a wireless communication system. For example, the core network device 130 may be a Mobility Management Entity (MME) in an Evolved Packet Core (EPC). Alternatively, the core network device may also be other core network devices, such as a Serving GateWay (SGW), a Public Data Network GateWay (PGW), a Policy and Charging Rules Function (PCRF) unit or a Home Subscriber Server (HSS). Alternatively, the core network device 130 may also be a core network device in 5G. For example, it may be a Policy Control Function (PCF), or a Session Management Function (SMF), an Access and Mobility Management Function (AMF), a Unified Data Management (UDM), or a User Plane Function (UPF). The embodiments of the present disclosure do not limit the implementation form(s) of the core network device 130.

In order to facilitate the understanding of those skilled in the art, the embodiments of the present disclosure list multiple implementations to clearly illustrate the technical solution in the embodiments of the present disclosure. It is noted, those skilled in the art shall understand that the multiple embodiments provided by the embodiments of the present disclosure may be executed separately, or may be executed together with the methods of other embodiments among the embodiments of the present disclosure, or may be executed separately or in combination with some methods in other related technologies. The embodiments of the present disclosure are not limited in this regard.

In order to better understand the technical solution described in any embodiment of the present disclosure, first, the application scenarios applicable to the present disclosure are partially explained.

Multimodal data is data that describes the same service or application and is input from the same device or different devices, and may be output to one or more destination devices. The data streams in the multimodal data often have a certain or even strong correlation, such as the synchronization of audio streams and video streams, and the synchronization of tactile data and visual data.

The XRM service characteristics require 5GS to comprehensively consider the QoS characteristics of the relevant data flows of the service, such as whether the parameters such as delay critical Guaranteed Bit Rate (GBR), Guaranteed Flow Bit Rate (GFBR), Packet Delay Budget (PDB) and/or Maximum Data Burst Volume (MDBV) can be met and coordinated at the same time. This involves multiple XRM data flows of a UE and XRM data flows of multiple UEs, and the consistency of QoS authorization and execution between each other is guaranteed. The uplink-downlink transmission coordination to meet Round-Trip latency requirements is a key issue in the 5GS XRM service study.

In related technologies, AF may provide PDB as latency requirements when requesting QoS, or provide a Round-Rrip (RT) requirement indication as an indication about whether the two-way delay needs to be considered, for reference to the network authorization.

However, the delay status in the actual service process is dynamically and continuously changed by various factors in the network. In particular, XRM services often require multiple data streams within the UE, or different data streams of multiple UEs, to be successfully authorized with the corresponding QoS in order to support service implementation. Therefore, the real-time or quasi-real-time delay status of the network, and the real-time delay requirements of the AF service will directly affect the QoS authorization of each data stream, and thus affect whether the support for the 5GS XRM service function can be successful.

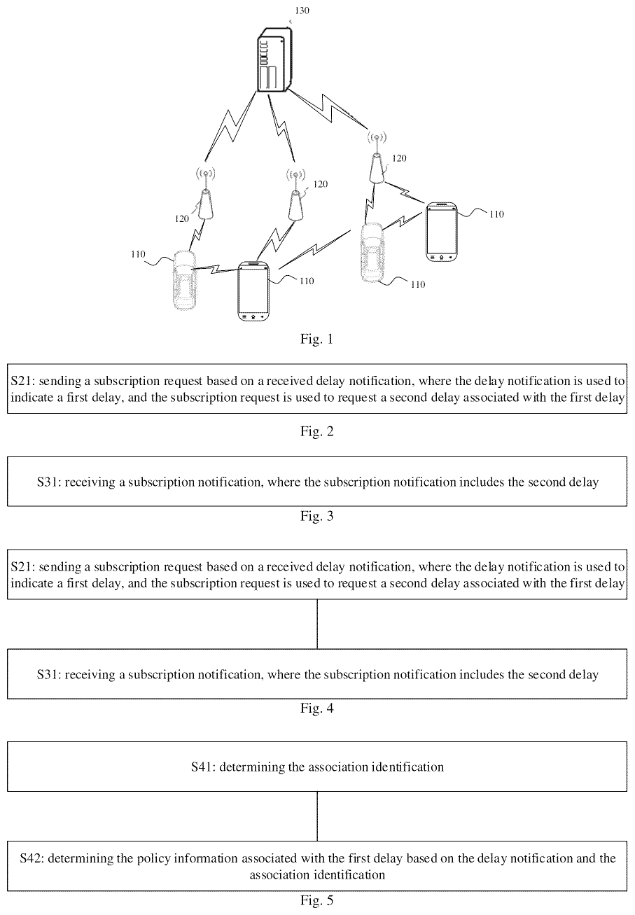

As shown in FIG. 2, the embodiments of the present disclosure provide an information processing method, which is performed by the PCF, and includes:
step S21: sending a subscription request based on a received delay notification, where the delay notification is used to indicate a first delay, and the subscription request is used to request a second delay associated with the first delay.

The PCF involved in the embodiments of the present disclosure and also the AF, UPF, SMF, NEF, and AMF involved below may all be logical nodes or functions that can be flexibly deployed in the communication network. For example, UPF, SMF, NEF, and AMF may all be logical nodes or functions that can be flexibly deployed in the core network.

In an embodiment, PCF, AF, UPF, SMF, NEF, and AMF may all be operator network elements. In another embodiment, PCF, UPF, SMF, NEF, and AMF are operator network elements, and AF is a third-party network element.

In an embodiment, SDF may be a data stream of any service. For example, SDF may be an XRM service quantity stream or an XR data stream. SDF may include an uplink SDF or a downlink SDF.

In an embodiment, the delay notification may be an SDF delay notification or an SDF delay monitoring report.

In an embodiment, the first delay may be an uplink delay, and the second delay may be a downlink delay. Alternatively, the first delay may be a downlink delay, and the second delay may be an uplink delay. For example, the uplink delay may be the delay of the uplink SDF, and the downlink delay may be the delay of the downlink SDF.

In an embodiment, the first delay includes the delay of the uplink SDF, and the second delay includes the delay of the downlink SDF. Alternatively, the first delay includes the delay of the downlink SDF, and the second delay includes the delay of the uplink SDF.

In an embodiment, the delay of the SDF includes at least one of the following: PDB or PSDB. For example, the PDB includes an uplink PDB and/or a downlink PDB. The PSDB includes an uplink PSDB and/or a downlink PSDB. For example, the first delay includes uplink PDB, and the second delay includes downlink PDB. Alternatively, the first delay includes downlink PDB, and the second delay includes uplink PDB. Alternatively, the first delay includes uplink PSDB, and the second delay includes downlink PSDB. Alternatively, the first delay includes downlink PSDB, and the second delay includes uplink PSDB.

In an embodiment, the second delay associated with the first delay is the downlink delay in the same two-way delay as the first delay. The first delay and the second delay are in the same two-way delay. For example, the two-way delay may be an RT delay.

In an embodiment, the delay notification includes the first delay. For example, the delay notification includes the delay of the uplink SDF or the delay of the downlink SDF.

In an embodiment, the subscription request includes reporting indication information, and the reporting indication information is used to indicate that the reporting mode is an immediate reporting mode.

The embodiments of the present disclosure provide an information processing method, which is performed by a PCF, and includes: receiving a delay notification.

In an embodiment, the delay notification may be carried in the SDF delay monitoring report. For example, the PCF receives the SDF delay monitoring report, and the SDF delay monitoring report includes the delay notification.

In another embodiment, the delay notification may be carried in the first information. For example, the PCF receives the first information, and the first information includes the delay notification.

In an embodiment, before step S21, the method includes: receiving the delay notification.

In some embodiments of the present disclosure, the information transmission (including sending and/or receiving) between the PCF and the UPF may be transmitted via other network elements. For example, it may be transparently transmitted via the SMF. For example, the PCF receiving the delay notification sent by the UPF may be: the PCF receiving, through the SMF, the delay notification sent by the UPF. That is, the UPF sends the delay notification to the SMF, and the SMF transparently transmits the delay notification to the PCF.

In some other embodiments of the present disclosure, the information transmission (including sending and/or receiving) between the PCF and the AF may be directly transmitted or indirectly transmitted. For example, the information transmission between the PCF and the AF may be indirectly transmitted via other network elements. For example, it may be transparently transmitted via the NEF or SMF. For example, the PCF sending the first delay to the AF may be: the AF directly sending the first delay to the AF; or the AF sending the first delay to the NEF, and the NEF transparently transmitting the first delay to the AF.

In an embodiment, receiving the delay notification includes: receiving, through the SMF, the delay notification sent by the UPF.

The embodiments of the present disclosure provide an information processing method, which is performed by the PCF, and includes: receiving, through the SMF, the delay notification sent by the UPF. For example, the UPF sends the delay notification to the SMF, and the SMF sends the delay notification to the PCF. In this way, the PCF can successfully receive, through the NEF, the delay notification sent by the UPF.

In some embodiments, sending the subscription request in step S21 includes: sending the subscription request to the UPF through the SMF.

The embodiments of the present disclosure provide an information processing method, which is performed by the PCF and includes: sending the subscription request to the UPF through the SMF. For example, the PCF sends the subscription request to the SMF, and the SMF sends the subscription request to the UPF. In this way, the PCF can successfully send, through the SMF, the subscription request to the UPF.

For example, PCF receives the delay notification sent by SMF, the delay notification includes the delay of the uplink SDF, and the delay notification is received by SMF from UPF. PCF sends the subscription request to SMF, and the subscription request is used to request the delay of the downlink SDF in the same two-way delay as the delay of the uplink SDF. SMF sends the subscription request to UPF.

For example, PCF receives the delay notification sent by SMF, the delay notification includes the delay of the downlink SDF, and the delay notification is received by SMF from UPF. PCF sends the subscription request to SMF, and the subscription request is used to request the delay of the uplink SDF in the same two-way delay as the delay of the downlink SDF. SMF sends the subscription request to UPF.

In an embodiment of the present disclosure, after receiving the delay notification through PCF, the subscription request may be sent. The delay notification is used to indicate the first delay, and the subscription request is used to request the second delay associated with the first delay. In this way, according to the embodiments of the present disclosure, the second delay can be requested after the first delay is received. For example, after receiving the delay of the uplink SDF, the delay of the downlink SDF is requested. Alternatively, after receiving the delay of the downlink SDF, the delay of the uplink SDF is requested. Thus, after PCF receives the second delay, it is beneficial for PCF to adjust the first delay and/or the second delay and/or the PCC rule of the first delay and/or the PCC rule of the second delay based on the transmission situation of the current service data flow, thereby optimizing the transmission of the service data flow and/or the QoS authorization of the service data flow.

In some embodiments, after step S21, the method further includes: receiving a subscription notification, where the subscription notification includes the second delay.

As shown in FIG. 3, the embodiments of the present disclosure provide an information processing method, which is performed by the PCF, and includes:
step S31: receiving a subscription notification, where the subscription notification includes the second delay.

In some embodiments, receiving the subscription notification includes: receiving, through SMF, the subscription notification sent by UPF.

The embodiments of the present disclosure provide an information processing method, which is performed by PCF, and includes: receiving, through SMF, the subscription notification sent by UPF. For example, UPF sends the subscription notification to SMF, and SMF sends the subscription notification to PCF. In this way, PCF can successfully receive the subscription notification through SMF, so that PCF obtains the second delay.

As shown in FIG. 4, the embodiments of the present disclosure provide an information processing method, which is performed by PCF, and includes:
step S21: sending a subscription request based on the received delay notification, where the delay notification is used to indicate the first delay, and the subscription request is used to request a second delay associated with the first delay;
step S31: receiving a subscription notification, where the subscription notification includes the second delay.

It should be noted that for the description of contents repeated or corresponding to the above-mentioned embodiment(s), such as the specific implementations of step S21 and step S31 in the embodiments of the present disclosure, reference may be made to the relevant parts of step S21 and step S31 in the above-mentioned embodiment(s), respectively, and no further description will be given here.

The present embodiment may be combined with other embodiments arbitrarily if there is no contradiction. Any solution (or example solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method(s) provided in the embodiments of the present disclosure may be performed alone or together with some methods in the embodiments of the present disclosure or some methods in related technologies.

In an embodiment, the subscription request includes reporting indication information, and the reporting indication information is used to indicate that the reporting mode is an immediate reporting mode.

The embodiments of the present disclosure provide an information processing method, which is performed by the PCF, and includes:
sending a subscription request based on the received delay notification, where the delay notification is used to indicate a first delay, the subscription request is used to request a second delay associated with the first delay, and the subscription request includes reporting indication information, where the reporting indication information is used to indicate that the reporting mode is an immediate reporting mode.

In some embodiments of the present disclosure, the delay notification and the subscription request may be the delay notification and the subscription request in the above-mentioned embodiment(s), respectively; the first delay and the second delay may be the first delay and the second delay in the above-mentioned embodiment(s), respectively.

For example, after receiving the subscription request including the reporting indication information, the UPF immediately reports the subscription notification. In an embodiment, the immediate reporting mode is immediate reporting. The immediate reporting may refer to reporting within a predetermined time range. For example, the immediate reporting may be reporting within 0.1 ms or 0.2 ms.

In an embodiment, the reporting indication information may also be used to indicate that the reporting mode is a trigger condition reporting mode or a periodic reporting mode. For example, the trigger condition reporting mode may be a mode for reporting when the trigger condition is met. Alternatively, the periodic reporting mode may be a mode for reporting based on a predetermined time interval (i.e., periodically). For example, if the reporting indication information is used to indicate that the reporting mode is a trigger condition reporting mode, the UPF sends the subscription notification based on the trigger condition reporting mode after receiving the subscription request including the reporting indication information. For another example, if the reporting indication information is used to indicate that the reporting mode is a periodic reporting mode, the UPF sends the subscription notification based on the periodic reporting mode after receiving the subscription request including the reporting indication information.

In an example embodiment, if the reporting indication information indicates one of multiple reporting modes, it may be indicated by different values. For example, the reporting indication information is a first value, for indicating that the reporting mode is an immediate reporting mode. Alternatively, the reporting indication information is a second value for indicating that the reporting mode is a trigger condition reporting mode. Further alternatively, the reporting indication information is a third value for indicating that the reporting mode is a periodic reporting mode.

In the embodiments of the present disclosure, the reporting indication information may be carried in the subscription request to indicate that the reporting mode is an immediate reporting mode. Thus, when the UPF receives the subscription request including the reporting indication information, the UPF can immediately report the subscription notification including the second delay. In this way, the reporting of the first delay and the second delay can be in a relatively short time, and the network status does not change much at this time, thereby improving the effectiveness of the first delay and the second delay.

In the embodiments of the present disclosure, if the reporting indication information is used to indicate other reporting modes, the present disclosure may be adapted to more application scenarios, and the UPF may be triggered to flexibly report the subscription notification.

The present embodiment may be arbitrarily combined with other embodiments if there is no contradiction. Any solution (or example solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method(s) provided in the embodiments of the present disclosure may be performed alone or together with some methods in the embodiments of the present disclosure or some methods in related technologies.

In some embodiments, the method further includes: determining association identification.

In some embodiments, after receiving the delay notification, the method further includes: determining the policy information associated with the first delay based on the delay notification and the association identification.

As shown in FIG. 5, the embodiments of the present disclosure provide an information processing method, which is performed by the PCF, and includes:
step S41: determining the association identification;
step S42: determining the policy information associated with the first delay based on the delay notification and the association identification.

In some embodiments, the association identification is used to indicate at least one of the following:
the association relationship between the first delay and the second delay;
the association relationship between the uplink SDF and the downlink SDF;
the association relationship between the PCC rule of the uplink SDF and the PCC rule of the downlink SDF; or
the association relationship between the 5QI of the first delay and the 5QI of the second delay.

In some embodiments of the present disclosure, the delay notification may be the delay notification in the above embodiment(s); the first delay and the second delay may be the first delay and the second delay in the above embodiment(s), respectively.

For example, the delay notification is used to indicate the first delay, or the delay notification includes the first delay.

For example, the first delay includes the delay of the uplink SDF, and the second delay includes the delay of the downlink SDF. Alternatively, the first delay includes the delay of the downlink SDF, and the second delay includes the delay of the uplink SDF. For example, the delay of the SDF includes at least one of the following: PDB or PSDB.

In an embodiment, the association identification may be Round Trip (RT) association identification. For example, the association identification may be at least one of the following: the association identification indicating the association relationship between the first delay and the second delay, the association identification indicating the association relationship between the PCC rule of the uplink SDF and the PCC rule of the downlink SDF, the association identification indicating the association relationship between the 5QI of the first delay and the 5QI of the second delay, or the association identification indicating the association relationship between the uplink SDF and the downlink SDF.

In another embodiment, the association identification includes, but is not limited to, at least one of the following: common identification (Common ID), Peer identification (Peer ID), Round Trip Group identification (Round Trip Group ID), and Peer Indication. For example, the common identification may be an identification of the associated RT delay uplink and downlink SDF generated by mapping the common ID sent by AF; and/or, the peer identification may be two associated identifications; and/or, the Round Trip Group identification may be two or more identifications; and/or, the Peer Indication may be an identification for distinguishing classes. For example, the Peer Indication may be used alone or together with other association identification (such as peer identification).

For example, the common identification included in the association identification may be generated based on or determined by mapping the common identification sent by AF. For example, the common identification sent by AF is an 8-bit identification, in which the first bit indicates the packet, and the second and third bits indicate the common delay. PCF determines that there are 10 data streams, and the 10 data streams include 5 pairs of SDFs, that is, 5 uplink SDFs and 5 downlink SDFs. Each pair of SDFs may be identified by different values. After obtaining the common identification sent by AF, PCF determines that the first bit of the common identification remains unchanged, and takes different values of the second and third bits to identify different pairs of SDFs. For example, when the second and third bits take the value “01”, they are used to identify the first pair of SDFs. In this way, the common identification included in the association identification can be generated based on or by mapping the common identification sent by AF. The common identification included in the association identification may be used to identify the associated uplink SDF and downlink SDF.

In an embodiment, the PCC rule may be any billing-related rule. The specific content of the PCC rule is not limited here.

In an embodiment, 5QI may be 5G QoS identification. For example, 5QI may be used to identify at least one of the following information: the address of the destination device of the data flow, the destination port of the data flow, the delay of the data flow, the bandwidth corresponding to the delay, the bit error rate of the data flow, or the scenario to which the data flow is applicable (such as conversation, voice or video, etc.).

In an embodiment, the association identification may be used to identify the uplink SDF, the downlink SDF, the delay of the uplink SDF, the delay of the downlink SDF, the PCC rule of the delay of the uplink SDF, the PCC rule of the delay of the downlink SDF, the 5QI of the delay of the uplink SDF and/or the 5QI of the delay of the downlink SDF.

In some embodiments, step S41 includes: determining the association identification based on demand information, service contract information and/or operator policy, where the demand information is a demand which indicates the two-way delay of the SDF.

The embodiments of the present disclosure provide an information processing method, which is performed by the PCF, and includes: determining the association identification based on demand information, service contract information and/or operator policy, where the demand information is a demand which indicates the two-way delay of the SDF.

In an embodiment, the demand information is information which is stored by PCF and indicates RT delay or two-way delay.

In another embodiment, the demand information is information which is sent by AF and indicates RT delay or two-way delay.

In an embodiment, AF may directly send the demand information to PCF. Alternatively, AF may also indirectly send the demand information to PCF through a core network element, which may be NEF or Time Sensitive Communication and Time Synchronization Function (TSCTSF), where NEF and TSCTSF send the demand information to PCF. For example, AF sends the demand information to NEF, and NEF sends the demand information to PCF. For example, AF sends the demand information to TSCTSF, and TSCTSF sends the demand information to PCF. For example, AF sends the demand information to NEF, NEF sends the demand information to TSCTSF, and TSCTSF sends the demand information to PCF.

In an embodiment, AF may send the demand information in at least one of the following processes: in the AF session request process, in the AF session update process, in the service-specific parameter provision process, and in the policy setting process for subsequent AF sessions. The AF session request process may be described in the communication protocol as: AF session with required QoS procedure. The AF session update process may be described in the communication protocol as: AF session with required QoS update procedure. The service-specific parameter provision process may be described in the communication protocol as: Service specific parameter provisioning. The policy setting process for subsequent AF sessions may be described in the communication protocol as: Set a policy for a future AF session.

In some embodiments, determining the association identification based on demand information, service contract information and/or operator policy includes at least one of the following:
determining the association identification based on demand information; determining the association identification based on demand information and service contract information;
determining the association identification based on demand information and operator policy; or determining the association identification based on demand information, service contract information and operator policy.

For example, the demand information may include RT delay and/or SDF related information. PCF may divide RT delay into uplink SDF delay and downlink SDF delay. Since PCF knows which uplink SDF delay is associated with which downlink SDF delay, that is, in the same RT delay, PCF may determine the association identification of the uplink SDF delay and the downlink SDF delay. That is, the association identification of the first delay and the second delay may be determined.

For example, PCF may also determine the PCC rules for uplink SDF and/or downlink SDF. At this time, PCF knows whether the two determined PCC rules are the PCC rule of the uplink SDF and the PCC rule of the downlink SDF in the same RT delay. Thus, PCF may determine the association identification of the PCC rule of the uplink SDF and the PCC rule of the downlink SDF. Similarly, PCF may also output the association identification of the 5QI of the uplink SDF delay and the 5QI of the downlink SDF.

In an embodiment, the service contract information is used to indicate whether the operator supports the RT delay function or the enhanced RT delay function.

In an embodiment, the service contract information may be XRM service contract information.

For example, based on the service contract information, the PCF determines that the A operator supports the RT delay function and/or the B operator does not support the RT delay function. Based on the demand information and the service contract information, the PCF may determine the association identification of the uplink SDF delay and the downlink SDF delay of the A operator, etc., and/or cannot determine the association identification of the uplink SDF delay and the downlink SDF delay of the B operator, etc.

In an embodiment, the operator policy is at least used to indicate: whether at least one service supports the RT delay function and/or whether at least one UE supports the RT delay function.

For example, if the operator policy is used to indicate that the UE of a VIP user supports the RT delay function and/or the UE of an ordinary user does not support the RT delay. For example, the PCF may determine the association identification of the uplink SDF delay and the downlink SDF delay of the UE of the VIP user based on the demand information and the operator policy, and/or cannot determine the association identification of the uplink SDF delay and the downlink SDF delay of the UE of the ordinary user.

In an embodiment of the present disclosure, the association identification may be accurately determined based on multiple methods, so that the PCF can determine the policy information of the second delay based on the association identification after receiving the first delay. Since the association identification may be determined based on multiple methods, more scenarios for determining the association identification can be applied.

In some embodiments, determining the policy information associated with the first delay in step S42, includes at least one of the following: determining the PCC rule of the SDF corresponding to the second delay; or determining the 5QI of the second delay.

In some other embodiments, the method further includes: determining the second delay associated with the first delay based on the association identification and the first delay in the delay notification.

The embodiments of the present disclosure provide an information processing method, which is performed by the PCF, and includes:
determining the second delay associated with the first delay based on the delay notification and the association identification;
determining the PCC rule of the SDF corresponding to the second delay based on the delay notification and the association identification;
determining the 5QI of the second delay based on the delay notification and the association identification.

The embodiments of the present disclosure provide an information processing method, which is performed by the PCF, and includes:
determining the second delay associated with the first delay based on the first delay and the association identification;
determining the PCC rule of the SDF corresponding to the second delay based on the first delay and the association identification;
determining the 5QI of the second delay based on the first delay and the association identification.

For example, the PCF obtains the first delay based on the delay notification, and determines the first association identification between the first delay and the second delay. The PCF may determine the second delay associated with the first delay based on the first delay and the first association identification. For example, the PCF obtains the delay of the uplink SDF, and the PCF stores the first association identification of the delay of the uplink SDF and the delay of the downlink SDF. Then, the PCF may determine the delay of the downlink SDF associated with the delay of the uplink SDF based on the uplink SDF and the first association identification.

For example, the PCF determines the PCC rule of the SDF corresponding to the first delay, and determines the second association identification of the PCC rule of the SDF corresponding to the first delay and the PCC rule of the SDF corresponding to the second delay. The PCF may determine the PCC rule of the SDF corresponding to the second delay associated with the PCC rule of the SDF corresponding to the first delay based on the PCC rule of the SDF corresponding to the first delay and the second association identification. For example, if the first delay is the delay of the uplink SDF, the PCC rule of the SDF corresponding to the first delay is the PCC rule of the uplink SDF. Alternatively, if the first delay is the delay of the downlink SDF, the PCC rule of the SDF corresponding to the first delay is the PCC rule of the downlink SDF.

For example, the PCF determines the 5QI of the first delay, and determines the third association identification of the 5QI of the first delay and the 5QI of the second delay. The PCF may determine the 5QI of the second delay associated with the 5QI of the first delay based on the 5QI of the first delay and the third association identification.

In an embodiment of the present disclosure, based on the association identification and the first delay in the delay notification, the policy information associated with the first delay (such as the second delay, the PCC rule of the second delay and/or the 5QI of the second delay) may be accurately determined. In this way, the PCF can determine the policy information of another delay requested by the demand after receiving the delay notification, so as to facilitate adjustment and optimization of the current policy information of the first delay and/or the second delay.

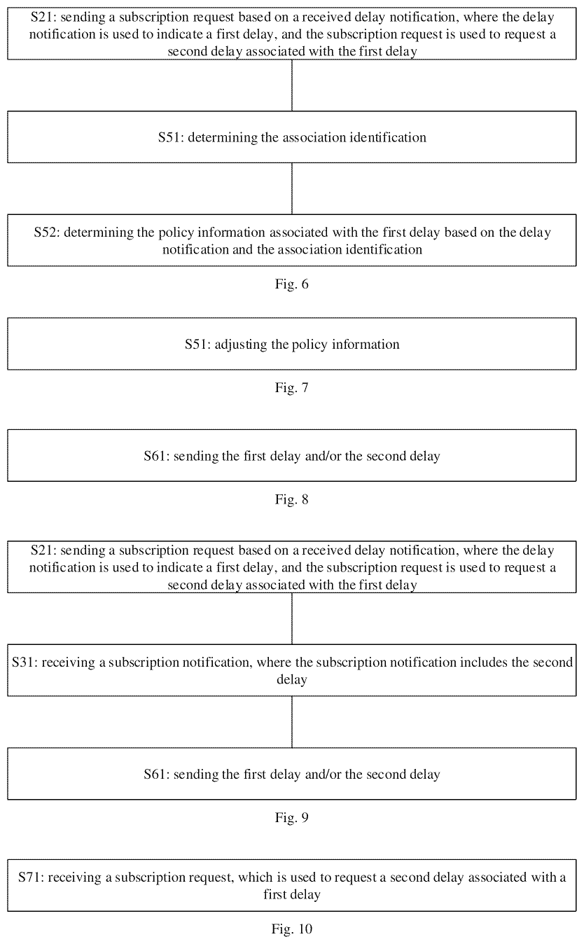

As shown in FIG. 6, the embodiments of the present disclosure provide an information processing method, which is performed by the PCF, and includes:
step S21: sending a subscription request based on the received delay notification, where the delay notification is used to indicate the first delay, and the subscription request is used to request the second delay associated with the first delay;
step S51: determining the association identification;
step S52: determining the policy information associated with the first delay based on the delay notification and the association identification.

It should be noted that for the description of the contents repeated or corresponding to the above-mentioned embodiment(s), such as the specific implementations of step S21, step S51 and step S52 in the embodiments of the present disclosure, reference may be made to the relevant parts of step S21, step 51 and step S52 in the above-mentioned embodiment(s), respectively, and no further description is given here.

The present embodiment may be arbitrarily combined with other embodiments if there is no contradiction. Any solution (or example solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

In some embodiments, after receiving the subscription notification, the method further includes: adjusting the policy information.

As shown in FIG. 7, the embodiments of the present disclosure provide an information processing method, which is performed by the PCF, and includes: step S51: adjusting the policy information.

In an embodiment, adjusting the policy information includes: adjusting the policy information based on the first delay and/or the second delay.

In some embodiments, adjusting the policy information includes at least one of the following:
adjusting the first delay and/or the second delay;
adjusting the PCC rule of the uplink SDF and/or adjusting the PCC rule of the downlink SDF; or
adjusting the 5QI of the first delay and/or adjusting the 5QI of the second delay.

The present disclosure provides an information processing method, which is performed by PCF, and includes:
adjusting the first delay and/or the second delay;
adjusting the PCC rule of the uplink SDF and/or adjusting the PCC rule of the downlink SDF;
adjusting the 5QI of the first delay and/or adjusting the 5QI of the second delay.

In some embodiments of the present disclosure, the first delay and the second delay may be the first delay and the second delay in the above embodiment(s), respectively, and the 5QI and the PCC rule may be the 5QI and the PCC rule in the above embodiment(s), respectively.

For example, the first delay includes the delay of the uplink SDF, and the second delay includes the delay of the downlink SDF. Alternatively, the first delay includes the delay of the downlink SDF, and the second delay includes the delay of the uplink SDF. For example, the delay of the SDF includes at least one of the following: PDB or PSDB.

For example, 5QI may be used to identify at least one of the following information: the address of the destination device of the data flow, the destination port of the data flow, the delay of the data flow, the bandwidth corresponding to the delay, the bit error rate of the data flow, or the scenario to which the data flow is applicable (such as conversation, voice or video, etc.).

For example, the PCF may adjust the first delay and/or the second delay of the SDF based on the first delay obtained by the delay notification and/or the second delay obtained by the subscription notification. For example, based on the delay notification and the subscription notification, PCF obtains that the delay of the uplink SDF is 15 ms and the delay of the downlink SDF is 35 ms. In this case, the delay redundancy of the uplink SDF is relatively high, and the delay of the downlink SDF is relatively tight. In this way, PCF may continuously reduce the delay of the uplink SDF, such as to 14 ms, 13 ms, etc., and continuously increase the delay of the downlink SDF, such as to 36 ms, 37 ms, etc., until the delay of the uplink SDF and the delay of the downlink SDF are adjusted to have relative margin. For example, the delay of the uplink SDF is adjusted to 10 ms and the delay of the downlink SDF is adjusted to 40 ms. For another example, the RT delay threshold of PCF may be 60 ms. Based on the delay notification and the subscription notification, PCF obtains that the delay of the uplink SDF is 15 ms and the delay of the downlink SDF is 35 ms. In this case, the delay of the uplink SDF has a margin but not much, but the delay of the downlink SDF is relatively tight. At this time, if the delay of the uplink SDF is reduced, the delay of the uplink SDF may be relatively tight. In this way, PCF can increase the delay of the downlink SDF to 40 ms without reducing the delay of the uplink SDF, so as to meet the transmission of the downlink SDF. Since the delay of the uplink SDF is 15 ms and the delay of the downlink SDF is 40 ms, not exceeding the RT delay threshold of 60 ms, PCF may adjust the delay of the downlink SDF to achieve a better transmission effect.

For example, the PCF may determine the PCC rule for the SDF corresponding to the first delay and/or the PCC rule for the SDF corresponding to the second delay based on the first delay and/or the second delay. For example, in the above embodiment(s), if the first delay and/or the second delay are adjusted, the PCF may adjust the PCC rule of the SDF corresponding to the first delay and/or the PCC rule of the SDF corresponding to the second delay accordingly, such as adjusting the PCC rule of the uplink SDF and/or the PCC rule of the downlink SDF.

For example, the PCF may allocate 5QI to the first delay and/or allocate 5QI to the second delay respectively based on the obtained first delay and/or second delay. If the first delay and/or the second delay are adjusted, the PCF may reallocate 5QI to the adjusted first delay and/or reallocate 5QI to the adjusted second delay, that is, adjust the 5QI of the first delay and/or the 5QI of the second delay.

In the embodiments of the present disclosure, after obtaining the first delay and/or the second delay (or obtaining the PCC rule of the SDF corresponding to the first delay and/or the second delay, and/or the 5QI of the first delay and/or the second delay), the PCF may readjust the policy information such as the first delay and/or the second delay, the PCC rule of the SDF corresponding to the first delay and/or the second delay, and/or the 5QI of the first delay and/or the second delay according to the network transmission and other conditions. In this way, the transmission of the SDF can be optimized. For example, by adjusting the appropriate first delay and/or second delay, the transmission effect of the uplink SDF and/or the downlink SDF can be achieved (for example, the success rate of data transmission in the SDF can be improved).

The present embodiment may be arbitrarily combined with other embodiments if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be executed alone or together with some methods in the embodiments of the present disclosure or some methods in related technologies.

As shown in FIG. 8, an embodiment of the present disclosure provides an information processing method, which is performed by the PCF, and includes:
step S61: sending a first delay and/or a second delay.

In some embodiments of the present disclosure, the first delay and the second delay may be the first delay and the second delay in step S21, respectively. For example, the first delay includes the delay of the uplink SDF, and the second delay includes the delay of the downlink SDF. Alternatively, the first delay includes the delay of the downlink SDF, and the second delay includes the delay of the uplink SDF. For example, the delay of the SDF includes at least one of the following: PDB or PSDB.

In an embodiment, the first delay and/or the second delay are used by the AF to trigger AF session modification and/or adjust policy information and/or request the PCF to adjust policy information.

In some embodiments, sending the first delay and/or the second delay includes one of the following:
sending the first delay and/or the second delay to the AF; or
sending the first delay and/or the second delay to the AF through the NEF.

The embodiments of the present disclosure provide an information processing method, which is performed by PCF, and includes: sending the first delay and/or the second delay to AF. In this way, PCF can directly send the first delay and/or the second delay to AF.

The embodiments of the present disclosure provide an information processing method, which is performed by PCF, and includes: sending the first delay and/or the second delay to AF through NEF. For example, PCF sends the first delay and/or the second delay to NEF, and NEF forwards the first delay and/or the second delay to AF. In this way, PCF can successfully send the first delay and/or the second delay to AF indirectly through NEF.

In some embodiments, step S61 includes one of the following:
sending the first delay and the second delay separately; or
sending the first delay and the second delay simultaneously.

The embodiments of the present disclosure provide an information processing method, which is performed by PCF, and includes:
sending the first delay and the second delay separately;
sending the first delay and the second delay simultaneously.

For example, after receiving the delay notification, PCF sends the first delay in the delay notification to AF through NEF. After receiving the subscription notification, PCE sends the second delay included in the subscription notification to AF through NEF. In this way, the embodiments of the present disclosure can send the first delay and the second delay to AF respectively, so that AF can obtain the first delay and/or the second delay in time.

For example, PCFE receives the delay notification, which includes the first delay. PCF receives the subscription notification, which includes the second delay. PCF carries the first delay and the second delay in the same information and sends it to AF. In this way, the embodiments of the present disclosure can send the first delay and the second delay together to AF, which can reduce the signaling overhead and the power consumption of the network element.

In the above embodiment(s), after PCF receives the subscription notification, the first delay and the second delay may be carried in different information and sent to AF at the same time. In this way, it is also possible to send the first delay and the second delay to AF separately.

As shown in FIG. 9, the embodiments of the present disclosure provide an information processing method, which is performed by the PCF, and includes:
step S21: sending a subscription request based on the received delay notification, where the delay notification is used to indicate the first delay, the subscription request is used to request a second delay associated with the first delay;
step S31: receiving a subscription notification, where the subscription notification includes the second delay;
step S61: sending the first delay and/or the second delay.

It should be noted that for the description of the contents repeated or corresponding to the above-mentioned embodiment(s), such as the specific implementations of step S21, step S31 and step S61 in the embodiments of the present disclosure, reference may be made to the relevant parts of step S21, step S31 and step S61 in the above-mentioned embodiment(s), respectively, and no further description is given here.

The present embodiment may be arbitrarily combined with other embodiments if there is no contradiction. Any solution (or example solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be executed alone or together with some methods in the embodiments of the present disclosure or some methods in related technologies.

The following information processing method is performed by UPF, which is similar to the description of the information processing method performed by PCF above. For the technical details not disclosed in the embodiment(s) of the information processing method performed by UPF, reference may be made to the description of the example(s) of the information processing method performed by PCF, which will not be described in detail here.

As shown in FIG. 10, the embodiments of the present disclosure provide an information processing method, which is performed by UPF, and includes:
step S71: receiving a subscription request, which is used to request a second delay associated with a first delay.

In some implementations provided by the embodiments of the present disclosure, the subscription request and the delay notification may be the subscription request and the delay notification in the above embodiment(s) respectively; the first delay and the second delay may be the first delay and the second delay in the above embodiment(s) respectively.

In an embodiment, the subscription request is sent by PCF after receiving the delay notification. The delay notification is used to indicate the first delay.

For example, the first delay includes the delay of the uplink SDF, and the second delay includes the delay of the downlink SDF. Alternatively, the first delay includes the delay of the downlink SDF, and the second delay includes the delay of the uplink SDF.

For example, the delay of the SDF includes at least one of the following: PDB or PSDB.

In some embodiments, before receiving the subscription request in step S71, the method further includes: sending a delay notification, where the delay notification is used to indicate the first delay.

In some embodiments, sending the delay notification includes: sending the delay notification to PCF through SMF.

The embodiments of the present disclosure provide an information processing method, which is performed by UPF, and includes: sending the delay notification to PCF through SMF. For example, UPF sends the delay notification to SMF, and SMF forwards the delay notification to PCF. In this way, UPF can successfully send the delay notification to PCF through SMF.

In some embodiments, after receiving the subscription request, the method further includes: sending a subscription notification, where the subscription notification includes the second delay.

The embodiments of the present disclosure provide an information processing method, which is performed by UPF, and includes: sending a subscription notification, the subscription notification including a second delay.

In some embodiments, sending the subscription notification includes: sending the subscription notification to PCF through SMF.

The embodiments of the present disclosure provide an information processing method, which is performed by UPF, and includes: sending a subscription notification to PCF through SMF. For example, UPF sends the subscription notification to SMF, and SMF sends the subscription notification to PCF. In this way, UPF can successfully send the subscription notification to PCF through SMF.

In some embodiments, the subscription request includes reporting indication information, and the reporting indication information is used to indicate that the reporting mode is an immediate reporting mode. Sending the subscription notification includes: sending the subscription notification based on the immediate reporting mode.

The embodiments of the present disclosure provide an information processing method, which is performed by UPF, and includes:
receiving a subscription request, where the subscription request includes an immediate reporting mode, and the subscription request is used to request a second delay associated with a first delay;
sending a subscription notification based on the immediate reporting mode.

In some embodiments, the delay notification is also used together with the association identification for the PCF to determine the policy information associated with the first delay. The policy information includes at least one of the following: the second delay, the PCC rule of the SDF corresponding to the second delay, or the 5QI of the second delay.

For the above implementation(s), reference may be made to the descriptions at the PCF side, which will not be repeated here.

The present embodiment may be combined with other embodiments in any way if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

The following information processing method is performed by SMF and is similar to the description of the information processing method performed by PCF and/or UPF above. For technical details not disclosed in the embodiment(s) of the information processing method performed by SMF, reference may be made to the description of the example(s) of the information processing method performed by PCF and/or UPF, which will not be described in detail here.

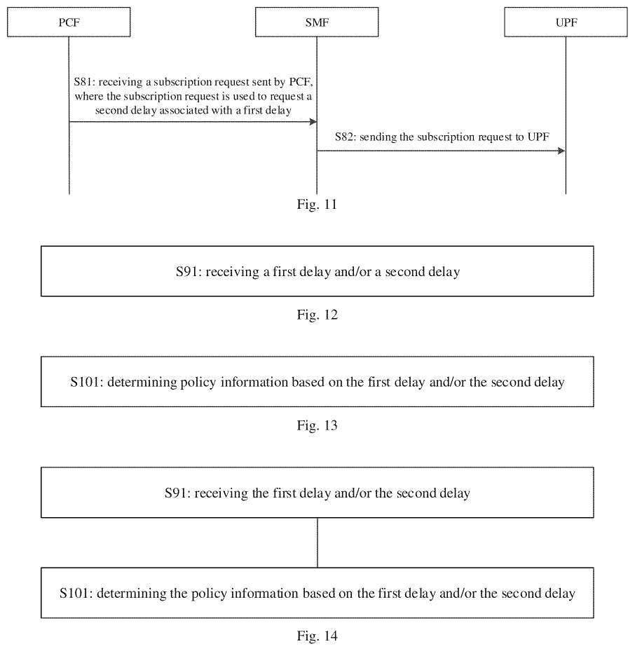

As shown in FIG. 11, the embodiments of the present disclosure provide an information processing method, which is performed by SMF, and includes:
step S81: receiving a subscription request sent by PCF, where the subscription request is used to request a second delay associated with the first delay;
step S82: sending the subscription request to UPF.

In some implementations provided by the embodiments of the present disclosure, the subscription request and the delay notification may be the subscription request and the delay notification in the above embodiment(s), respectively; the first delay and the second delay may be the first delay and the second delay in the above embodiment(s), respectively. For example, the first delay includes the delay of the uplink SDF, and the second delay includes the delay of the downlink SDF. Or, the first delay includes the delay of the downlink SDF, and the second delay includes the delay of the uplink SDF. For example, the delay of SDF includes at least one of the following: PDB or PSDB.

In an embodiment, the subscription request includes reporting indication information, where the reporting indication information is used to indicate that the reporting mode is an immediate reporting mode.

In some embodiments, before receiving the subscription request sent by PCF, the method further includes: receiving the delay notification sent by UPF; sending the delay notification to PCF.

The embodiments of the present disclosure provide an information processing method, which is performed by SMF, and includes: receiving the delay notification sent by UPF; sending the delay notification to PCF.

In an embodiment, the delay notification is used to indicate the first delay.

In an embodiment, the delay notification includes the first delay.

In some embodiments, after sending the subscription request to UPF, the method also includes: receiving the subscription notification sent by UPF, where the subscription notification includes the second delay; sending the subscription notification to PCF.

The embodiments of the present disclosure provide an information processing method, which is performed by SMF, and includes: receiving the subscription notification sent by UPF, where the subscription notification includes the second delay; sending the subscription notification to PCF.

In some embodiments, after sending the subscription notification to PCF, the method further includes: receiving the first delay and/or the second delay sent by UPF; sending the first delay and/or the second delay to AF.

The embodiments of the present disclosure provide an information processing method, which is performed by SMF, and includes: receiving the first delay and/or the second delay sent by UPF; sending the first delay and/or the second delay to AF.

For the above implementations, reference may be made to the description at the PCF and/or UPF side, which will not be repeated here.

The present embodiment may be combined with other embodiments in any way if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

The following information processing method is performed by AF and is similar to the description of the information processing method performed by PCF and/or UPF and/or SMF as mentioned above. For the technical details not disclosed in the embodiment(s) of the information processing method performed by AF, reference may be made to the description of the example(s) of the information processing method performed by PCF and/or UPF and/or SMF, which will not be described in detail here.

As shown in FIG. 12, the embodiments of the present disclosure provide an information processing method, which is performed by AF, including:
step S91: receiving a first delay and/or a second delay.

In an example embodiment, the first delay and the second delay are determined by PCF based on a delay notification and a subscription notification, respectively. The delay notification and/or subscription notification is provided by UPF.

In some implementations provided by the embodiments of the present disclosure, the subscription request and the delay notification may be the subscription request and the delay notification in the above embodiment(s), respectively; the first delay and the second delay may be the first delay and the second delay in the above embodiment(s), respectively.

For example, the first delay includes the delay of the uplink SDF, and the second delay includes the delay of the downlink SDF. Alternatively, the first delay includes the delay of the downlink SDF, and the second delay includes the delay of the uplink SDF.

For example, the delay of the SDF includes at least one of the following: PDB or PSDB.

In some embodiments, receiving the first delay and/or the second delay in step S91 includes one of the following:
receiving the first delay and/or the second delay sent by UPF through PCF;
receiving the first delay and/or the second delay sent by UPF; or
receiving, through NEF, the first delay and/or the second delay sent by PCF or UPF or SMF.

The embodiments of the present disclosure provide an information processing method, which is performed by AF, including:
receiving, through PCF, the first delay and/or the second delay sent by UPF;
receiving the first delay and/or the second delay sent by UPF;
receiving the first delay and/or the second delay sent by PCF or UPF or SMF through NEF.

For example, PCF may directly send the first delay and/or the second delay to AF.

Alternatively, UPF may directly send the first delay and/or the second delay to AF. In this way, AF may directly receive the first delay and/or the second delay sent by PCF or UPF.

For example, PCF sends the first delay and/or the second delay to NEF, and NEF sends the first delay and/or the second delay to AF. Alternatively, UPF sends the first delay and/or the second delay to NEF, and NEF sends the first delay and/or the second delay to AF. Alternatively, UPF sends the first delay and/or the second delay to SMF, and SMF sends the first delay and/or the second delay to AF. In this way, AF can indirectly receive the first delay and/or the second delay sent by UPF or PCF through network elements such as NEF.

The present embodiment may be combined with other embodiments arbitrarily if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

As shown in FIG. 13, the embodiments of the present disclosure provide an information processing method, which is performed by AF, including: step S101: determining policy information based on the first delay and/or the second delay.

In some embodiments, step S101 includes at least one of the following:
determining the second delay based on the first delay;
determining the PCC rule corresponding to the second delay based on the first delay and/or the second delay; or
determining the 5QI of the second delay based on the first delay and/or the second delay.

The embodiments of the present disclosure provide an information processing method, which is performed by AF, and includes at least one of the following:
determining the second delay based on the first delay;
determining the PCC rule corresponding to the second delay based on the first delay and/or the second delay; or
determining the 5QI of the second delay based on the first delay and/or the second delay.

In some embodiments of the present disclosure, the way for determining policy information at the AF side is similar to the way for adjusting policy information at the PCF side; the step of determining policy information at the AF side may refer to the step of adjusting policy information at the PCF side in the above embodiment(s).

In some embodiments of the present disclosure, the AF may also trigger AF session modification based on the first information and/or the second information.

As shown in FIG. 14, the embodiments of the present disclosure provide an information processing method, which is performed by AF, including:
step S91: receiving the first delay and/or the second delay;
step S101: determining the policy information based on the first delay and/or the second delay.

It should be noted that for the description of the contents repeated or corresponding to the above-mentioned embodiments, such as the specific implementations of step S91 and step S101 in the embodiments of the present disclosure, reference may be made to the relevant parts of step 91 and step S101 in the above-mentioned embodiments, and no further description is given here.

For the above implementations, reference may be made to the descriptions at the PCF and/or UPF and/SMF side, and no further description is given here.

The present embodiment may be combined with other embodiments in any way if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

The following information processing method is performed by NEF and is similar to the description of the information processing method performed by PCF and/or UPF and/or SMF and/or AF. For technical details not disclosed in the embodiments of the information processing method performed by NEF, reference may be made to the description of the examples of the information processing method performed by PCF and/or UPF and/or SMF and/or AF, which will not be described in detail here.

The embodiments of the present disclosure provide an information processing method, which is performed by NEF, including:
receiving a first delay and/or a second delay sent by PCF;
sending a first delay and/or a second delay to AF.

In some embodiments of the present disclosure, the first delay and/or the second delay may be the first delay and the second delay in the above embodiment(s), respectively. For example, the first delay includes the delay of the uplink SDF, and the second delay includes the delay of the downlink SDF. Or, the first delay includes the delay of the downlink SDF, and the second delay includes the delay of the uplink SDF.

For example, the delay of the SDF includes at least one of the following: PDB or PSDB.

In an embodiment, the first delay and/or the second delay are used by AF to trigger AF session modification and/or adjust policy information and/or request PCF to adjust policy information.

For the above implementations, reference may be made to the descriptions at the PCF and/or UPF and/or SMF and/or AF side, which will not be repeated here.

The present embodiment may be combined with other embodiments in any way if there is no contradiction. Any solution (or optional solution) in the present embodiment may be combined with each other if there is no contradiction. Any solution in the present embodiment may be combined with any solution in other embodiments if there is no contradiction. The steps in the present embodiment may be exchanged in order if there is no contradiction.

It should be noted, those skilled in the art can understand that the method provided in the embodiments of the present disclosure may be performed alone or together with some methods in the embodiments of the present disclosure or some methods in related technologies.

In order to further explain any embodiment of the present disclosure, several specific embodiments are provided below.

### Example 1

As shown in FIG. 15, the embodiments of the present disclosure provide an information processing method, which is performed by a communication device, and the communication device includes: UE, RAN device, AMF, SMF, UPF, PCF, NEF and AF. The information processing method includes the following steps.

In step S1101: AF sends an AF request, where the AF request carries demand information.

For example, the AF request may be an AF session resource request. AF creates the AF request through Nnef_AFsession WithQoS_Create request. AF carries demand information in the AF request. The demand information is used to indicate the demand for the RT delay of the service data flow. The RT delay may be, but not limited to, uplink delay and downlink delay. The demand information may include, but is not limited to, at least one of the following.

For example, the AF request may also include XRM service information. The XRM service information may be, but not limited to, at least one of the following: common identification, UE address information, UE identifier, application identifier, flow identification, DNN, S-NSSAI, or QoS parameter. The common identification is used to indicate all the data flows in the group of service data flows. The UE identifier is used to indicate the UE related to the service data flow. The application identification information is used to indicate the service data flow. The flow description is used to indicate the characteristic information of the service data flow. The QoS parameter may be, but is not limited to: PDU Set Error Rate (PSER), PDU Set Delay Budget (PSDB) and/or PDU Set Integrated Indication (PSII), etc. For example, the service data flow may be a data flow of an XRM service or XR or other various services.

In step S1102: NEF authorizes the AF request.

For example, if AF is an untrusted AF, the AF request sent by AF may be provided to PCF via NEF. For example, NEF performs relevant mappings, including: mapping of XRM service identification (such as AF-Service-Identifier) to DNN and S-NSSAI, mapping of external application to Core Network (CN) application identification; and Unified Data Management (UDM) contract information, mapping of external UE identification to UE identification within CN (such as SUPI), and mapping of external to internal XRM service group identification according to UDM contract information.

In step S1103: NEF sends the AF request to PCF.

For example, NEF sends the AF request to PCF, and the AF request carries demand information. The AF request is used for PCF policy decision. For example, the AF request also includes XRM service information.

In step S1104: PCF makes a policy decision based on the demand information.

In some embodiments of the present disclosure, the delay notification and the subscription notification may be the delay notification and the subscription notification in the above embodiment(s), respectively; the first delay and the second delay may be the first delay and the second delay in the above embodiment(s), respectively; the policy information may be the policy information in the above embodiment(s).

For example, making the policy decision includes, but is not limited to: determining policy information (including policy information related to the delay of the uplink SDF and/or the delay of the downlink SDF), adjusting policy information, determining association identification, and/or sending the delay of the uplink SDF and/or the delay of the downlink SDF, etc.

For example, PCF divides the value of the two-way delay (e.g., RT latency) into UL PDB (i.e., uplink delay) and DL PDB (i.e., downlink delay). PCF generates a PCC rule corresponding to the UL PDB and a PCC rule corresponding to the DL PDB, and allocates corresponding 5QIs to the UL PDB and the DL PDB, respectively. For example, the two PCC rules should also have an associated QoS monitoring policy. For example, the UL PDB may be the delay of the uplink SDF, and/or the DL PDB may be the delay of the downlink SDF.

For example, after receiving the delay notification, PCF sends the subscription request to UPF through SMF. The delay notification includes the delay of the uplink SDF. The subscription request is used to request the delay of the downlink SDF associated with the delay of the uplink SDF. After receiving the subscription request, UPF sends the subscription notification to PCF through SMF, and the subscription notification includes the delay of the downlink SDF. For example, the subscription request sent by PCF also includes reporting indication information, and the reporting indication information is used to indicate that the reporting mode is an immediate reporting mode. After UPF receives the subscription request including the reporting indication information, it reports the subscription notification based on the immediate reporting mode, and for instance, vice versa. For example, if the delay notification received by PCF includes the delay of the downlink SDF, the subscription request sent to UPF through SMF is used to request the delay of the uplink SDF associated with the downlink SDF. Besides, after receiving the subscription request, UPF sends the subscription notification including the delay of the uplink SDF to PCF through SMF.

For example, PCF may generate association identification (e.g., RT association identification) for a service data flow (uplink SDF and/or downlink SDF). The association identification may be, but is not limited to, a common identification (Common ID), a Peer Identification (Peer ID), a Round Trip Group Identification (Round Trip Group ID), and/or a Peer Indication, etc. For example, the association identification may be used to indicate, but is not limited to, at least one of the following: the association relationship between the delay of the uplink SDF and the delay of the downlink SDF, the association relationship between the uplink SDF and the downlink SDF, the association relationship between the PCC rule of the uplink SDF and the PCC rule of the downlink SDF, or the association relationship between the 5QI of the delay of the uplink SDF and the 5QI of the delay of the downlink SDF.

For example, after receiving a delay notification including the delay of the uplink SDF, PCF determines the policy information associated with the delay of the uplink SDF based on the association identification. For example, PCF may identify the downlink SDF, the PCC rule corresponding to the downlink SDF, and the 5QI allocated to the downlink SDF based on the association identification. For example, PCF may send, through SMF, a subscription request to UPF, for requesting the delay of the downlink SDF. After receiving the subscription request, UPF sends a subscription notification including the delay of the downlink SDF to UPF through SMF, and for example, vice versa. If receiving a delay notification including the delay of the downlink SDF, PCF determines the policy information associated with the delay of the downlink SDF based on the association identification. For example, PCF may identify the uplink SDF, the PCC rule corresponding to the uplink SDF, and the 5QI allocated to the uplink SDF based on the association identification.

For example, PCF may adjust the policy information based on the QoS monitoring report (e.g., delay notification and/or subscription notification, and also such as the first delay and/or the second delay). For example, PCF may adjust the PCC rule of the uplink SDF, the PCC rule of the downlink SDF, the delay of the uplink SDF, the delay of the downlink SDF, the 5QI of the uplink SDF (which may also be the 5QI corresponding to the delay of the uplink SDF) and/or the 5QI of the downlink SDF (which may also be the 5QI corresponding to the delay of the downlink SDF). For example, after receiving the QoS monitoring report of the uplink SDF, the PCF may find the PCC rule of the downlink SDF based on the association identification. PCF may adjust the PCC rule of the uplink SDF and/or the PCC rule of the downlink SDF together.

For example, PCF may determine the association identification based on demand information (such as RT delay), and/or XRM service contract information and/or operator policy. For example, if the demand information and/or XRM service contract information and/or operator policy indicate support for the rule of RT delay and/or 5QI update, it is determined to generate the association identification. The association identification is used to indicate the association relationship between the delay of the uplink SDF and the delay of the downlink SDF, the association relationship between the uplink SDF and the downlink SDF, the association relationship between the PCC rule of the uplink SDF and the PCC rule of the downlink SDF, and the association relationship between the 5QI of the delay of the uplink SDF and the 5QI of the delay of the downlink SDF.

For example, PCF adjusts the policy information based on the QoS monitoring report (for example, adjusts the PCC rule of the uplink SDF and/or the PCC rule of the downlink SDF), which may be PCF directly triggering the update of the policy information (for example, the PCC rule), or PCF sending the QoS monitoring report to AF for the AF to trigger the update of the policy information (for example, the PCC rule).

For example, PCF sends the delay of the uplink SDF and/or the delay of the downlink SDF to AF. For example, after receiving the delay notification including the delay of the uplink SDF sent by UPF, PCF sends a subscription request for requesting the delay of the downlink SDF, where UPF sends the subscription notification including the delay of the downlink SDF to PCF. Alternatively, after receiving the delay notification including the delay of the downlink SDF sent by UPF, PCF sends a subscription request for requesting the delay of the uplink SDF, where UPF sends the subscription notification including the delay of the uplink SDF to PCF. Further, PCF sends the delay of the uplink SDF or the delay of the downlink SDF to AF separately. Alternatively, PCF waits and receives the subscription notification, and then sends the delay of the uplink SDF and the delay of the downlink SDF together to AF.

For example, PCF may adjust the policy information directly or indirectly. For example, it may update the PCC rule of the uplink SDF and/or the PCC rule of the downlink SDF, the delay of the uplink SDF and/or the delay of the downlink SDF, and/or the 5QI allocated to the updated delay of the uplink SDF and/or the updated delay of the downlink SDF.

In an example embodiment, PCF may receive the demand information provided by AF. For example, AF may send the demand information to PCF based on one of the following processes: AF session request process (AF session with required QoS procedure), AF session update process (AF session with required QoS update procedure), service specific parameter provisioning process (Service specific parameter provisioning), and process to set a policy for a future AF session (Set a policy for a future AF session).

In step S1105: PCF sends an authorization response to NEF.

For example, the authorization response may be Npcf_Policy Authorization_Create response. The authorization response may be used to indicate whether the PCF decision policy is authorized.

In step S1106: NEF sends an authorization response to AF.

For example, the authorization response may be Nnef_AFsession WithQoS_Create response. The authorization response may be used to indicate whether the AF request is authorized.

In step S1107: PCF sends an update request to SMF.

For example, the update request may be an SM Policy Association Modification Request. The update request includes the PCC rule. For example, based on the measured QoS monitoring policy from PCF, SMF generates a QoS monitoring configuration for UPF (for example, or RAN device).

In step S1108: SMF sends an update response to PCF.

For example, the update response may be an SM Policy Association Modification Response.

In step S1109: SMF sends an N4 session modification request to UPF.

For example, the N4 session modification request may be an N4 Session Modification Request. The N4 session modification request includes (QOS monitoring configuration).

In step S1110: SMF receives a response returned by UPF based on the N4 session modification request.

For example, after receiving the QoS monitoring configuration, UPF enables measurement and reporting. UPF responds to SMF.

In step S1111: AMF and SMF exchange N1N2 message;

For example, AMF receives a session modification request sent by SMF, and calls Namf_Communication_N1N2 message based on the session modification request. The Namf_Communication_N1N2 message includes PDU session ID, QFI(s), QoS profile, QoS monitoring configuration and/or N1 SM container.

In step S1112: AMF sends N2 message, NAS message and N1 SM container to RAN device.

For example, them N2 message is received by AMF from SMF. The NAS message includes the ID of the PDU session. The N1 SM container includes PDU Session Modification Command. After receiving the QoS monitoring configuration, the RAN device enables measurement and reporting (for example, the RAN device measures the delay of the uplink SDF and the delay of the downlink SDF, and takes the sum of the delay of the uplink SDF and the delay of the downlink SDF as the RT delay).

In step S1103: resource setting is performed between RAN device and UE. This step S813 is optional.

In step S1114: RAN device sends a session confirmation message to AMF.

For example, the session confirmation message is used to confirm the session modification request. The session confirmation message may be an N2 PDU Session Ack Message.

In step S1115: AMF sends a session update request to SMF.

For example, AMF forwards the session confirmation message (including the N2 SM message) received from the RAN device to SMF through the Nsmf_PDUSession_UpdateSMContext service operation.

In step S1116: SMF sends a session update response to AMF.

For example, SMF responds to the session update request using the Nsmf_PDUSession_UpdateSMContext Response (i.e., the session update response).

In step S1117: SMF sends an N4 session modification request to UPF.

For example, the N4 session modification request may be an N4 Session Modification Request.

In step S1118: UPF sends an N4 session modification response to SMF.

For example, the N4 session modification response may be an N4 Session Modification Response.

For example, when PCF receives the measurement and/or report based on the QoS monitoring configuration subsequently, it will send the measurement and/or report to AF, and trigger the modification of related resources and/or trigger the AF session update process or the AF session release process.

In an example embodiment, after step S1118, if PCF receives a QoS monitoring report (such as delay notification and/or subscription notification, such as the first delay and/or the second delay), PCF may also make a policy decision. The policy decision includes, but is not limited to: determining policy information (including policy information of the delay of the uplink SDF and/or the delay of the downlink SDF), adjusting policy information, determining association identification, and/or sending the delay of the uplink SDF and/or the delay of the downlink SDF, etc.

For example, after receiving the delay notification, PCF sends a subscription request to UPF through SMF. The delay notification includes the delay of the uplink SDF, and the subscription request is used to request the delay of the downlink SDF associated with the delay of the uplink SDF. After receiving the subscription request, UPF sends a subscription notification to PCF through SMF, and the subscription notification includes the delay of the downlink SDF. For example, the subscription request sent by PCF also includes reporting indication information, and the reporting indication information is used to indicate that the reporting mode is an immediate reporting mode. After receiving the subscription request including the reporting indication information, UPF reports the subscription notification based on the immediate reporting mode, and for example, vice versa.

For example, PCF may adjust policy information based on the QoS monitoring report (such as delay notification and/or subscription notification, such as first delay and/or second delay). For example, PCF may adjust the PCC rule of the uplink SDF, the PCC rule of the downlink SDF, the delay of the uplink SDF, the delay of the downlink SDF, the 5QI of the delay of the uplink SDF, and/or the 5QI of the delay of the downlink SDF.

For example, PCF adjusts policy information based on the QoS monitoring report, which may be PCF directly triggering the update of the policy information, or PCF sending the QoS monitoring report to AF for AF to trigger the update of the policy information.

For example, PCF sends the delay of the uplink SDF and/or the delay of the downlink SDF to AF. PCF sends the delay of the uplink SDF or the delay of the downlink SDF to AF separately. Alternatively, PCF waits and receives the subscription notification, and then sends the delay of the uplink SDF and the delay of the downlink SDF to AF together.

For example, the process of QoS monitoring report to AF may be the process of user plane (UP) from UPF to AF in the above embodiment(s), or may be the process of control plane (CP) from UPF to SMF to PCF (to AF).

The present embodiment may be combined with other embodiments without contradiction. Any solution (or optional solution) in the present embodiment may be combined with each other without contradiction. Any solution in the present embodiment may be combined with any solution in other embodiments without contradiction. The steps in the present embodiment may be exchanged in order without contradiction. Each step in the present embodiment may be used as a separate embodiment. Any steps in the present embodiment may be combined with each other without contradiction.

For the above implementations, reference may be made to the descriptions at the PCF side and/or UPF side and/or AF side and/or SMF side, which will not be repeated here.

It should be noted, those skilled in the art can understand that the method provided in the embodiments of the present disclosure may be performed alone or together with some methods in the embodiments of the present disclosure or some methods in related technologies.

### Example 2

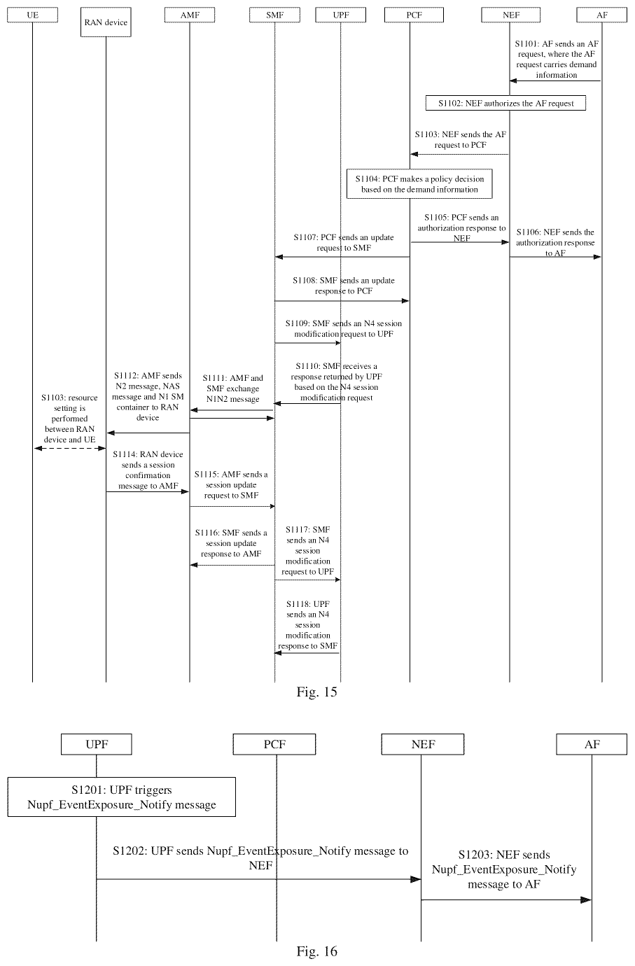

As shown in FIG. 16, the embodiments of the present disclosure provide an information processing method, which is performed by a communication device, and the communication device includes: UPF, PCF, NEF and AF. The information processing method includes the following steps.

In step S1201: UPF triggers Nupf_EventExposure_Notify message.

For example, when UPF detects measurement and/or reaches an event, it will trigger a report (for example, when a threshold is reached or a periodic timer times out, a report is triggered). UPF triggers Nupf_EventExposure_Notify message.

In step S1202: UPF sends Nupf_EventExposure_Notify message to NEF.

For example, UPF sends Nupf_EventExposure_Notify message, which includes the status information of the measured RT delay. For example, the Nupf_EventExposure_Notify message may also report a QoS measurement report.

For example, UPF may also report the status information of the measured RT delay to AF or report it to AF through NEF, so that AF can trigger a corresponding AF session update (for example, UPF may send the QoS measurement report to AF or send it to AF through NEF). Alternatively, UPF sends the QoS measurement report (such as delay notification and/or subscription notification, such as first delay and/or second delay) to PCF or sends it to PCF through SMF, so that PCF can trigger a policy decision. PCF may trigger an update policy locally or send a QoS measurement report to AF for AF to update the policy. For example, the first delay and the second delay may be the first delay and the second delay in the above embodiment(s), respectively; the policy may be the policy in the above embodiment(s).

In step S1203: NEF sends Nupf_EventExposure_Notify message to AF.

The present embodiment may be be combined with other embodiments arbitrarily if there is no contradiction. Any solution (or example solution) in the present embodiment may be combined with each other if there is no contradiction. Any solution in the present embodiment may be combined with any solution in other embodiments if there is no contradiction. The steps in the present embodiment may be exchanged in order if there is no contradiction. Each step in the present embodiment may be used as a separate embodiment. Any steps in the present embodiment may be combined with each other if there is no contradiction.

For the above implementations, reference may be made to the descriptions at the PCF side and/or UPF side and/or AF side and/or SMF side, which will not be repeated here.

It should be noted, those skilled in the art can understand that the method provided in the embodiments of the present disclosure may be performed alone or together with some methods in the embodiments of the present disclosure or some methods in related technologies.

### Example 3

In an application scenario, as shown in FIG. 15, the UE among the network elements is the user's device, the PCF, AF, UPF, SMF, NEF and AMF may all be operator network elements, and the RAN device is the device connecting the UE and the operator network element(s).

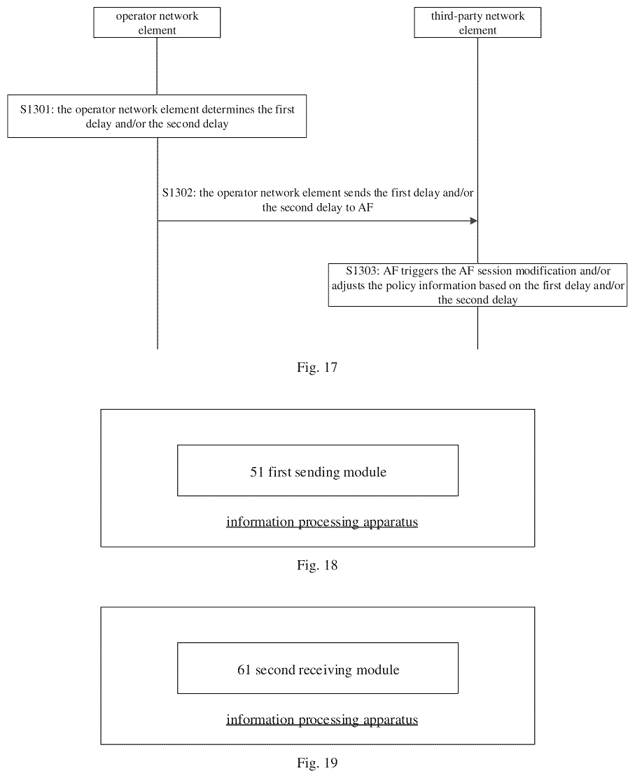

In another application scenario, as shown in FIG. 15, the UE among the network elements is the user's device, the PCF, UPF, SMF, NEF and AMF may all be operator network elements, the RAN device is the device connecting the UE and the operator network element(s), and the AF is a third-party network element. As shown in FIG. 17, the embodiments of the present disclosure provide an information processing method, which is performed by a communication system. The communication system includes an operator network element and a third-party network element. The information processing method includes the following steps.

In step S1301: the operator network element determines the first delay and/or the second delay.

For example, the operator network element obtains the first delay based on the delay notification, and obtains the second delay based on the subscription notification.

In step S1302: the operator network element sends the first delay and/or the second delay to AF.

In step S1303: AF triggers the AF session modification and/or adjusts the policy information based on the first delay and/or the second delay.

In some embodiments of the present disclosure, the delay notification and the subscription notification may be the delay notification and the subscription notification in the above embodiment(s) respectively; the first delay and the second delay may be the first delay and the second delay in the above embodiment(s) respectively; the policy information may be the policy information in the above embodiment(s).

In an optional embodiment, the method further includes: the operator network element determines the association identification; and determines the policy information associated with the first delay based on the delay notification and the association identification.

In some embodiments of the present disclosure, the association identification and the policy information are respectively the association identification and the policy information in the above embodiment(s); the first delay and the second delay may be the first delay and the second delay in the above embodiment(s) respectively.

In an example embodiment, the method further includes: the operator network element adjusts the policy information based on the first delay and/or the second delay. For example, adjusting the policy information includes at least one of the following: adjusting the first delay and/or the second delay; adjusting the PCC rule of the uplink SDF and/or adjusting the PCC rule of the downlink SDF; and adjusting the 5QI of the first delay and/or adjusting the 5QI of the second delay.

The present embodiment may be combined with other embodiments without contradiction. Any solution (or example solution) in the present embodiment may be combined with each other without contradiction. Any solution in the present embodiment may be combined with any solution in other embodiments without contradiction. The steps in the present embodiment may be exchanged in order without contradiction. Each step in the present embodiment may be implemented as a separate implementation. Any steps in the present embodiment may be combined with each other without contradiction.

For the above implementations, reference may be made to the descriptions at the PCF side and/or UPF side and/or AF side and/or SMF side, which will not be repeated here.

It should be noted, those skilled in the art can understand that the method provided in the embodiments of the present disclosure may be performed alone or together with some methods in the embodiments of the present disclosure or some methods in related technologies.

As shown in FIG. 18, the embodiments of the present disclosure provide an information processing apparatus, including a first sending module 51.

The first sending module 51 is configured to send a subscription request based on a received delay notification. The delay notification is used to indicate a first delay. The subscription request is used to request a second delay associated with the first delay.

The information processing apparatus provided by the embodiments of the present disclosure may be PCF.

In some embodiments, the first delay includes the delay of the uplink SDF, and the second delay includes the delay of the downlink SDF. Alternatively, the first delay includes the delay of the downlink SDF, and the second delay includes the delay of the uplink SDF.

In some embodiments, the delay of the SDF includes at least one of the following: PDB or PSDB.

The embodiments of the present disclosure provide an information processing apparatus, including a first sending module 51. The first sending module 51 is configured to send a subscription request based on a received delay notification. The delay notification is used to indicate the delay of the uplink SDF. The subscription request is used to request the delay of the downlink SDF associated with the delay of the uplink SDF.

The embodiments of the present disclosure provide an information processing apparatus, including a first sending module 51. The first sending module 51 is configured to send a subscription request based on a received delay notification. The delay notification is used to indicate the delay of the downlink SDF. The subscription request is used to request the delay of the uplink SDF associated with the delay of the downlink SDF.

In some embodiments, the subscription request includes reporting indication information, and the reporting indication information is used to indicate that the reporting mode is an immediate reporting mode.

The embodiments of the present disclosure provide an information processing apparatus, including a first sending module 51. The first sending module 51 is configured to send a subscription request based on a received delay notification. The delay notification is used to indicate a first delay. The subscription request is used to request a second delay associated with the first delay. The subscription request includes reporting indication information. The reporting indication information is used to indicate that the reporting mode is an immediate reporting mode.

The embodiments of the present disclosure provide an information processing apparatus, including: a first processing module, configured to determine association identification.

The embodiments of the present disclosure provide an information processing apparatus, including a first processing module. The first processing module is further configured to determine policy information associated with the first delay based on the delay notification and the association identification.

In some embodiments, the association identification is used to indicate at least one of the following:
the association relationship between the first delay and the second delay;
the association relationship between the uplink SDF and the downlink SDF;
the association relationship between the PCC rule of the uplink SDF and the PCC rule of the downlink SDF; or
the association relationship between the 5QI of the first delay and the 5QI of the second delay.

The embodiments of the present disclosure provide an information processing apparatus, including: a first processing module, configured to perform at least one of the following:
determining the PCC rule of the SDF corresponding to the second delay; or
determining the 5QI of the second delay.

The embodiments of the present disclosure provide an information processing apparatus, including: a first processing module, configured to determine the association identification based on demand information, service contract information and/or operator policy. The demand information is a demand which indicates the two-way delay of the SDF.

The embodiments of the present disclosure provide an information processing apparatus, including: a first receiving module, configured to receive a subscription notification, where the subscription notification includes the second delay.

The embodiments of the present disclosure provide an information processing apparatus, including: a first processing module, configured to adjust the policy information.

The embodiments of the present disclosure provide an information processing apparatus, including: a first processing module, configured to adjust the policy information based on the first delay and/or the second delay.

The embodiments of the present disclosure provide an information processing apparatus, including: a first processing module, configured to perform at least one of the following:
adjusting the first delay and/or the second delay;
adjusting the PCC rule of the uplink SDF and/or adjusting the PCC rule of the downlink SDF; or
adjusting the 5QI of the first delay and/or adjusting the 5QI of the second delay.

The embodiments of the present disclosure provide an information processing apparatus, including: a first sending module 51, configured to send the first delay and/or the second delay.

The embodiments of the present disclosure provide an information processing apparatus, including: a first sending module 51, configured to perform one of the following:
sending the first delay and the second delay separately; or
sending the first delay and the second delay simultaneously.

The embodiments of the present disclosure provide an information processing apparatus, including: a first sending module 51, configured to perform one of the following:
sending the first delay and/or the second delay to AF; or
sending the first delay and/or the second delay to AF through NEF.

The embodiments of the present disclosure provide an information processing apparatus, including: a first receiving module, configured to receive a subscription notification sent by SMF, where the subscription notification is received by SMF from UPF.

The embodiments of the present disclosure provide an information processing apparatus, including: a first receiving module, configured to receive, through SMF, a subscription notification sent by UPF.

The embodiments of the present disclosure provide an information processing apparatus, including: a first sending module 51, configured to send a subscription request to UPF through SMF.

As shown in FIG. 19, the embodiments of the present disclosure provide an information processing apparatus, including a second receiving module 61.

The second receiving module 61 is configured to receive a subscription request. The subscription request is used to request a second delay associated with a first delay.

The information processing apparatus provided by the embodiments of the present disclosure may be UPF.

In some embodiments, the first delay includes the delay of the uplink SDF, and the second delay includes the delay of the downlink SDF. Alternatively, the first delay includes the delay of the downlink SDF, and the second delay includes the delay of the uplink SDF.

In some embodiments, the delay of the SDF includes at least one of the following: a PDB or a PSDB.

In some embodiments, the subscription request includes reporting indication information, and the reporting indication information is used to indicate that the reporting mode is an immediate reporting mode. The apparatus further includes: a second sending module, configured to send a subscription notification based on the immediate reporting mode.

The embodiments of the present disclosure provide an information processing apparatus, including: a second sending module, configured to send a subscription notification based on the immediate reporting mode.

The embodiments of the present disclosure provide an information processing apparatus, including: a second sending module, configured to send a delay notification, where the delay notification includes a first delay.

The embodiments of the present disclosure provide an information processing apparatus, including: a second sending module, configured to send a delay notification to PCF through SMF.

The embodiments of the present disclosure provide an information processing apparatus, including: a second sending module, configured to send a subscription notification, where the subscription notification includes a second delay.

The embodiments of the present disclosure provide an information processing apparatus, including: a second sending module, configured to send a subscription notification to PCF through SMF.

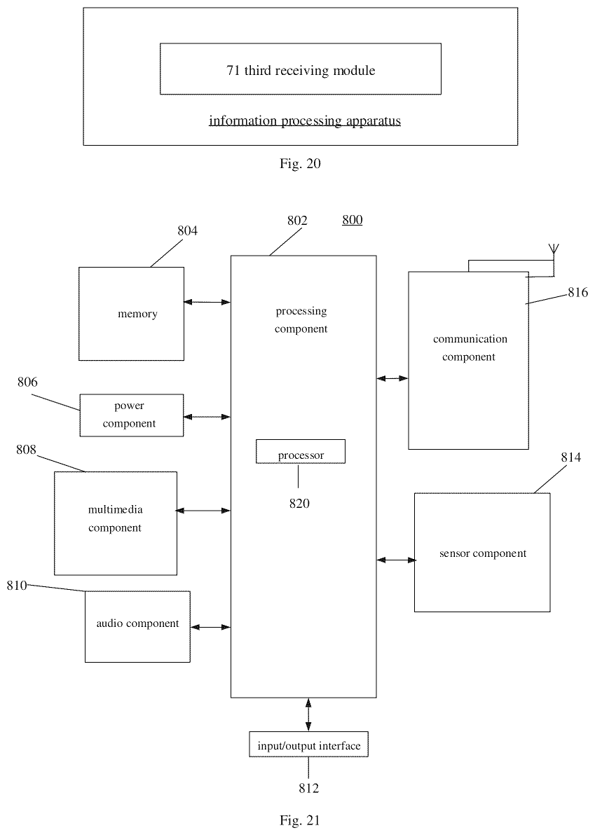

As shown in FIG. 20, the embodiments of the present disclosure provide an information processing apparatus, including a third receiving module 71.

The third receiving module 71 is configured to receive a first delay and/or a second delay.

In an embodiment, the first delay and the second delay are determined by PCF based on the delay notification and the subscription notification, respectively. The delay notification and/or the subscription notification are provided by UPF.

The information processing apparatus provided by the embodiments of the present disclosure may be AF.

In some embodiments, the first delay includes the delay of the uplink SDF, and the second delay includes the delay of the downlink SDF. Alternatively, the first delay includes the delay of the downlink SDF, and the second delay includes the delay of the uplink SDF.

In some embodiments, the delay of the SDF includes at least one of the following: PDB or PSDB.

The embodiments of the present disclosure provide an information processing apparatus, including: a third receiving module 71, configured to perform one of the following: receiving, through PCF, the first delay and/or the second delay sent by UPF; receiving the first delay and/or the second delay sent by UPF; or receiving, through NEF, the first delay and/or the second delay sent by PCF or UPF or SMF.

The embodiments of the present disclosure provide an information processing apparatus, including: a second processing module, configured to determine policy information based on the first delay and/or the second delay.

The embodiments of the present disclosure provide an information processing apparatus, including: a second processing module, configured to perform at least one of the following:
determining the second delay based on the first delay;
determining the PCC rule corresponding to the second delay based on the first delay and/or the second delay; or determining the 5QI of the second delay based on the first delay and/or the second delay.

It should be noted, those skilled in the art can understand that the apparatus provided by the embodiments of the present disclosure may be executed alone or together with some apparatuses in the embodiments of the present disclosure or some apparatuses in related technologies.

Regarding the apparatus in the above embodiment(s), the specific mode in which each module performs the operation has been described in detail in the method embodiment(s), and will not be elaborated here.

The embodiments of the present disclosure provide a communication device, including: a processor, and a memory for storing executable instructions of the processor.

The processor is configured to implement the information processing method in any embodiment of the present disclosure when running the executable instructions.

In an embodiment, the communication device may include, but is not limited to, at least one of: AF, PCF, UPF, SMF, NEF, AMF, RAN device, or UE.

The processor may include various types of storage media, which are non-transitory computer storage media that can continue to memorize the information stored thereon after the user device loses power.

The processor may be connected to the memory through a bus, etc., for reading an executable program stored on the memory, for example, at least one of the methods shown in FIGS. 2 to 17.

The embodiments of the present disclosure also provide a computer storage medium, which stores a computer executable program. When the executable program is executed by the processor, the information processing method in any embodiment of the present disclosure is implemented, for example, at least one of the methods shown in FIGS. 2 to 17.

Regarding the apparatus/device or storage medium in the above embodiment(s), the specific way in which each module performs the operation has been described in detail in the method embodiment(s), and will not be elaborated here.

FIG. 21 is a block diagram of a user device 800 according to an example embodiment. For example, the user device 800 may be a mobile phone, a computer, a digital broadcast user device, a messaging device, a game console, a tablet device, a medical device, a fitness device, a personal digital assistant, etc.

Referring to FIG. 21, the user device 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the user device 800, such as operations associated with display, phone calls, data communications, camera operations, and recording operations. The processing component 802 may include one or more processors 820 to execute instructions to complete all or some of the steps of the above method(s). In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support the operation of the user device 800. Examples of such data include instructions for any application or method operating on the user device 800, contact data, phone book data, messages, pictures, videos, etc. The memory 804 may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

The power component 806 provides power to various components of the user device 800. The power component 806 may include a power management system, one or more power supplies, and other components associated with generating, managing and distributing power for the user device 800.

The multimedia component 808 includes a screen that provides an output interface between the user device 800 and the user. In some embodiments, the screen may include a Liquid Crystal Display (LCD) and a Touch Panel (TP). If the screen includes a touch panel, the screen may be implemented as a touch screen to receive input signals from the user. The touch panel includes one or more touch sensors to sense touch, slide, and gestures on the touch panel. The touch sensor can sense not only the boundary of the touch or slide action, but also the duration and pressure associated with the touch or slide operation. In some embodiments, the multimedia component 808 includes a front camera and/or a rear camera. When the user device 800 is in an operating mode, such as a shooting mode or a video mode, the front camera and/or the rear camera can receive external multimedia data. Each of the front camera and the rear camera may be a fixed optical lens system or have a focal length and optical zooming capability.

The audio component 810 is configured to output and/or input audio signals. For example, the audio component 810 includes a microphone (MIC). When the user device 800 is in an operating mode, such as a call mode, a recording mode, and a voice recognition mode, the microphone is configured to receive an external audio signal. The received audio signal may be further stored in the memory 804 or sent via the communication component 816. In some embodiments, the audio component 810 also includes a speaker for outputting audio signals.

The I/O interface 812 provides an interface between the processing component 802 and the peripheral interface module, which may be a keyboard, a click wheel, buttons, etc. These buttons may include, but are not limited to, a home button, a volume button, a start button, and a lock button.

The sensor component 814 includes one or more sensors for providing various aspects of status assessment for the user device 800. For example, the sensor component 814 may detect the on/off state of the user device 800, the relative positioning of components, such as the display and keypad of the user device 800. The sensor component 814 may also detect the position change of the user device 800 or a component of the user device 800, the presence or absence of contact between the user and the user device 800, the orientation or acceleration/deceleration of the user device 800, and the temperature change of the user device 800. The sensor component 814 may include a proximity sensor, which is configured to detect the presence of a nearby object without any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the user device 800 and other devices. The user device 800 may access a wireless network based on a communication standard, such as WiFi, 4G, or 5G, or a combination thereof. In an example embodiment, the communication component 816 receives a broadcast signal or broadcast-related information from an external broadcast management system via a broadcast channel. In an example embodiment, the communication component 816 also includes a Near Field Communication (NFC) module to facilitate short-range communication. For example, the NFC module may be implemented based on Radio Frequency Identification (RFID) technology, Infrared Data Association (IrDA) technology, Wltra-WideBand (UWB) technology, Bluetooth (BT) technology and other technologies.

In an example embodiment, the user device 800 may be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above method(s).

In an example embodiment, a non-transitory computer-readable storage medium including instructions is also provided, such as a memory 804 including instructions. The instructions may be executed by a processor 820 of a user device 800 to complete the above method(s). For example, the non-transitory computer-readable storage medium may be a ROM, a Random Access Memory (RAM), a CD-ROM, a tape, a floppy disk, and an optical data storage device, etc.

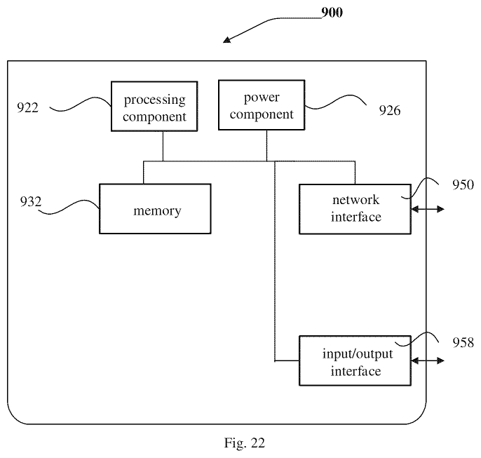

As shown in FIG. 22, an embodiment of the present disclosure shows a structure of a base station. For example, the base station 900 may be provided as a network side device. Referring to FIG. 22, the base station 900 includes: a processing component 922, which further includes one or more processors; and a memory resource represented by a memory 932 for storing instructions being executable by the processing component 922, such as an application. The application stored in the memory 932 may include one or more modules each corresponding to a set of instructions. In addition, the processing component 922 is configured to execute instructions to implement the above method(s), and any previous method(s) applied to the base station.

The base station 900 may also include: a power component 926, configured to perform power management of the base station 900; a wired or wireless network interface 950, configured to connect the base station 900 to a network; and an Input/Output (I/O) interface 958. The base station 900 may operate based on an operation system stored in the memory 932, such as Windows Server™, Mac OS X™, Unix™, Linux™, FreeBSD™, or the like.

Other embodiments of the present disclosure will be readily apparent to those skilled in the art after considering the specification and practicing the contents disclosed herein. The present disclosure is intended to cover any variation, use or adaptation of the present disclosure, which follows the general principle of the present disclosure and includes common knowledge or conventional technical means in the art that are not disclosed in the present disclosure. The description and embodiments are to be regarded as examples only, and the true scope and spirit of the present disclosure are indicated by the following claims.

It should be understood that the present disclosure is not limited to the precise structure(s) described above and shown in the accompanying drawings, and various modifications and changes may be made without departing from the scope of the present disclosure. The scope of the present disclosure is limited only by the appended claims.

1. An information processing method, wherein the method is performed by a Policy Control Function (PCF) and comprises:
sending a subscription request based on a received delay notification, wherein the delay notification is used to indicate a first delay, and the subscription request is used to request a second delay associated with the first delay,
wherein the first delay comprises a delay of an uplink Service Data Flow (SDF) and the second delay comprises a delay of a downlink SDF; or
the first delay comprises the delay of the downlink SDF and the second delay comprises the delay of the uplink SDF.

2. (canceled)

3. The method according to claim 1, wherein the delay of the SDF comprises at least one of: a Packet Delay Budget (PDB) or a PDU Set Delay Budget (PSDB).

4. The method according to claim 1, wherein
the subscription request comprises reporting indication information, wherein the reporting indication information is used to indicate that a reporting mode is an immediate reporting mode.

5. The method according to claim 1, wherein the method further comprises comprising:
determining association identification; and
determining policy information associated with the first delay based on the delay notification and the association identification.

6. The method according to claim 5, wherein the association identification is used to indicate at least one of:
an association relationship between the first delay and the second delay;
an association relationship between an uplink SDF and a downlink SDF;
an association relationship between a Policy and Charging Control (PCC) rule of the uplink SDF and the PCC rule of the downlink SDF; or
an association relationship between a 5G Quality of Service Identifier (5QI) of the first delay and the 5QI of the second delay,
wherein determining the policy information associated with the first delay comprises at least one of:
determining the PCC rule of the SDF corresponding to the second delay; or
determining the 5QI of the second delay;
wherein determining the association identification comprises:
determining the association identification based on at least one of demand information, service contract information or operator policy, wherein the demand information is a demand indicating a two-way delay of the SDF.

7. (canceled)

8. (canceled)

9. The method according to claim 1, wherein after sending the subscription request, the method further comprises:
receiving a subscription notification, wherein the subscription notification comprises the second delay,
wherein after receiving the subscription notification, the method further comprises:
adjusting the policy information,
wherein adjusting the policy information comprises at least one of:
adjusting at least one of the first delay or the second delay;
adjusting at least one of a PCC rule of an uplink SDF or a PCC rule of a downlink SDF; or
adjusting at least one of a 5QI of the first delay or a 5QI of the second delay.

10. (canceled)

11. (canceled)

12. The method according to claim 1, further comprising:
sending at least one of the first delay or the second delay,
wherein sending at least one of the first delay or the second delay comprises:
sending the first delay and the second delay separately; or
sending the first delay and the second delay simultaneously,
wherein sending at least one of the first delay or the second delay comprises:
sending at least one of the first delay or the second delay to an Application Function (AF); or
sending at least one of the first delay or the second delay to the AF through a Network Exposure Function (NEF).

13. (canceled)

14. (canceled)

15. The method according to claim 9, wherein receiving the subscription notification comprises:
receiving, through a Session Management Function (SMF), the subscription notification sent by a User Plane Function (UPF),
wherein before sending the subscription request, the method further comprises:
receiving, through the SMF, the delay notification sent by the UPF,
wherein sending the subscription request comprises:
sending the subscription request to the UPF through the SMF.

16. (canceled)

17. (canceled)

18. An information processing method, wherein the method is performed by a User Plane Function (UPF) and comprises:
receiving a subscription request, wherein the subscription request is used to request a second delay associated with a first delay,
wherein the first delay comprises a delay of an uplink Service Data Flow (SDF) and the second delay comprises a delay of a downlink SDF; or
the first delay comprises the delay of the downlink SDF and the second delay comprises the delay of the uplink SDF.

19. (canceled)

20. The method according to claim 18, wherein the delay of the SDF comprises at least one of: a Packet Delay Budget (PDB) or a PDU Set Delay Budget (PSDB).

21. The method according to claim 18, wherein
the subscription request comprises reporting indication information, wherein the reporting indication information is used to indicate that a reporting mode is an immediate reporting mode; and
after receiving the subscription request, the method further comprises: sending the subscription notification in the immediate reporting mode.

22. The method according to claim 18, wherein before receiving the subscription request, the method further includes:
sending a delay notification, wherein the delay notification is used to indicate the first delay.

23. An information processing method, wherein the method is performed by an Application Function (AF) and comprises:
receiving at least one of the first delay or the second delay,
wherein the first delay comprises a delay of an uplink Service Data Flow (SDF) and the second delay comprises a delay of a downlink SDF; or
the first delay comprises the delay of the downlink SDF and the second delay comprises the delay of the uplink SDF.

24. (canceled)

25. The method according to claim 23, wherein the delay of the SDF includes at least one of: a Packet Delay Budget (PDB) or a PDU Set Delay Budget (PSDB).

26. The method according to claim 23, wherein receiving at least one of the first delay or the second delay comprises:
receiving, through a Policy Control Function (PCF), at least one of the first delay or the second delay sent by a User Plane Function (UPF);
receiving at least one of the first delay or the second delay sent by the UPF; or
receiving, through a Network Exposure Function (NEF), at least one of the first delay or the second delay sent by the PCF or the UPF or a Session Management Function (SMF).

27. The method according to claim 23, further comprising:
determining policy information based on at least one of the first delay or the second delay,
wherein determining the policy information based on at least one of the first delay or the second delay comprises at least one of:
determining the second delay based on the first delay;
determining a Policy and Charging Control (PCC) rule corresponding to the second delay based on at least one of the first delay or the second delay; or determining a 5G Quality of Service Identifier (5QI) of the second delay based on at least one of the first delay or the second delay.

28-31. (canceled)

32. A communication device, comprising:
a processor; and
a memory for storing executable instructions of the processor, wherein
the processor is configured to: perform the information processing method according to claim 1.

33. (canceled)

34. A communication device, comprising:
a processor; and
a memory for storing executable instructions of the processor, wherein
the processor is configured to perform the information processing method according to claim 18.

35. A communication device, comprising:
a processor; and
a memory for storing executable instructions of the processor, wherein
the processor is configured to perform the information processing method according to claim 23.
